(19) United States
(12) Patent Application Publication
(10) Pub. No.: US 2010/0080231 A1
(43) Pub. Date: Apr. 1, 2010

(54) Method and system for restoration of a packet arrival order by an information technology system

(76) Inventors: Deepak Lala, Fremont, CA (US); Nayan Amrutlal Suthar, Pune (IN); Umesh Ramkrishnarao Kasture, Pune (IN)

Correspondence Address: PATRICK REILLY, P.O. BOX 7218, SANTA CRUZ, CA, 95061-7218, US

(21) Appl. No.: 12/286,120

(22) Filed: Sep. 26, 2008

(51) Int. Cl. H04L 12/56

(52) U.S. Cl. 370/394; 370/412

(57) ABSTRACT

A system and method for restoring the arrival order of a plurality of packets after receipt of the packets and prior to a retransmission of the plurality of packets are provided. The invented system is configured to process a first number of packets through a high latency path, and then process all remaining packets through a lower latency path. The received packets are stored after processing in a queue memory until either (a.) all of the packets processed through the high latency path are fully processed through the high latency path, or (b.) a time period of packet processing has expired. The packets stored in the queue are transmitted from the system in the order in which the packets were received by the system, and the additional data packets are retransmitted without storage in the queue memory. A method for allocating system resources for memory queue use is further provided

### FIELD OF THE INVENTION

The present invention relates to information technology systems that receive and process electronic messages. The present invention more particularly relates to restoring an arrival order of a plurality of packets after receipt and processing of the plurality of packets by an information technology system

### BACKGROUND OF THE INVENTION

Electronic messages, such as though transmitted over the Internet and conforming to the Transmission Control Protocol and Internet Protocol, or “TCP/IP”, are often separated into data packets. In the prior art, a plurality of packets may be derived from a same originating electronic message and may be transmitted over the Internet as a data flow to a receiving network address. Each data packet may include a header, wherein the header of each data packet identifies a data flow that comprises the plurality of packets that are generated from a same originating electronic message.

A receiving computer will receive the data packets of a same data flow in an arrival order and then often attempt to process the associated plurality of data packets in the arrival order. In particular, in the prior art when a receiving computer forwards on a plurality of packets of a same data flow, the receiving computer will typically be programmed to transmit the data packets of this data flow in the same order as the data packets were received. As packets may be processed at different rates within the receiving computer, prior art methods require that memory resources be committed to collecting the packets of a data flow in a dedicated queue, and then writing the assembled data packets from each separate queue after each and every packet of a same data flow has been written into a particular dedicated memory queue. There is, therefore, a long felt need to reduce the memory resources used by a receiving computer in processing data packets and forwarding data packets to another network element.

The header of a data packet, such as a data packet conforming to the Internet Protocol, may further specify a data type of a payload of the packet, a packet number, a total number of packets comprising a data flow, and a packet sender's network address and an intended receiver's network address.

In particular, a data packet conforming to the message format Internet Protocol (hereafter, “IP packet”) may include (a.) 4 bits that specify the Internet Protocol version to which the IP packet conforms, e.g., version 4 or version 6 of the Internet Protocol; (b.) 4 bits that contain specify the length of the header; (c.) 8 bits that identify the Quality of Service (or “QoS”), which identifies the priority at which the packet should be process; (d.) 16 bit's that specify the length of the comprising packet in bytes; (e.) 13 bits that contain a fragment offset, i.e., a field that identifies to which fragment the comprising packet is attached; (f.) 8 bits that identify a communications protocol to which the comprising packet conforms, e.g., the Transmission Control Protocol, the User Datagram Protocol, or the Internet Control Message Protocol; (g.) 32 bits that contain a source Internet Protocol address, or “IP address”; and (h.) 32 bits that contain an intended destination IP address.

A receiving computer is thus provided information within each IP packet that is useful in processing and associating a plurality of packets comprised within a same data flow. In the processing of a data flow, a first number of received packets may be analyzed and processed by a slower process than the remaining packets. This transition from a high latency path to a lower latency path may occur because of determinations made by the receiving computer after the first received number of packets are analyzed and processed. There may thus be only one transition in the latency period in processing the plurality of packet of a data flow, yet this latency may cause the processed data packets of a same data flow to be organized within the receiving computer out the arrival order of the data packets. The prior art teaches that a receiving computer must devote computational resources to restoring the processed data packets of a same data flow into the arrival order of the received data packets. Yet the prior art fails to best reduce the amount of memory that must be applied restore the processed packets into the arrival order.

### OBJECTS OF THE INVENTION

It is an object of the present invention to provide a method to transmit a plurality of packets of a same dataflow by a network element in an order in which the network element received the data packets.

It is a further optional object of the present invention to provide a system that is configured to reduce the computational resources applied to transmit a plurality of packets of a same data flow in the same order that the plurality of packets were received.

Additional objects and advantages of the present invention will be set forth in the description that follows, and in part will be obvious from the description, or may be learned by practice of the present invention. The objects and advantages of the present invention may be realized and obtained by means of the instrumentalities and combinations particularly pointed out in the appended claims.

### SUMMARY OF THE INVENTION

Towards this object and other objects that will be made obvious in light of this disclosure, a first version of the method of the present invention provides a system for restoring the arrival order of a plurality of packets after receipt of the packets and prior to a retransmission of the plurality of packets.

The invented system is configured to process a first number of packets through a high latency path, and then process all remaining packets through a lower latency path. The received packets are stored after processing in a queue memory until either (a.) all of the packets processed through the high latency path are fully processed through the high latency path, or (b.) a time period of packet processing has expired. The time period is specified to avoid storing the packets when a packet is dropped by the high latency path.

The packets stored in the queue are transmitted from the invented system in the order in which the packets were received by the invented system, and the additional data packets are retransmitted without storage in the queue memory.

In certain alternate embodiments of the method of the present invention, a buffer memory resource of a network computer that is communicatively coupled with an electronics communications network includes one or more of the following aspects of: (a.) determining a maximum packet latency T of a processing of a packet; (b.) determining a maximum data rate G of the network computer; (c.) assigning a memory buffer for temporarily storing data packets in the range of 0.8 to 1.2 of the result of T times G; (d.) determining a maximum rate R of a single data flow; (e.) determining a quantity Q of resource queues; and/or (f.) assigning a memory buffer for temporarily storing data packets of a capacity in the range of 0.8 to 1.2 T times Q times R.

The foregoing and other objects, features and advantages will be apparent from the following description of the preferred embodiment of the invention as illustrated in the accompanying drawings.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

United States Patent Application Publication No. 20030229839 (Inventors: Wang, Xiaolin, et al.; published Dec. 11, 2003) entitled “Method of and apparatus for protecting against and correcting errors in data packet flow streams in closed ring sequential address generators and the like and in other data pack flow paths, without data flow stream interruption”; United States Patent Application Publication No. 20040141510 (Inventors: Blanc, Alain, et al.; published Jul. 22, 2004) entitled “CAM based system and method for re-sequencing data packets”; United States Patent Application Publication No. 20060159104 (Inventors: Nemirovsky, Mario, et al.; published Jul. 20, 2006) entitled “Queueing system for processors in packet routing operation”; United States Patent Application Publication No. 20060153197 (Inventors: Nemirovsky, Mario, et al.; published Jul. 13, 2006) entitled “Queueing system for processors in packet routing operations”; United States Patent Application Publication No. 20060036705 (Inventors: Musoll, Enrique, et al.; published Feb. 16, 2006) entitled “Method and apparatus for overflowing data packets to a software-controlled memory when they do not fit into a hardware-controlled memory”, United States Patent Application Publication No. 20080050118 (Inventors: Haran, Onn, et al.; published Feb. 28, 2008) entitled “Methods and Systems for Bandwidths Doubling in an Ethernet Passive Optical Network”; and United States Patent Application Publication Serial No. 20060064508 (Inventors: Panwar, Ramesh, et al.; published on Mar. 23, 2006) entitled “Method and system to store and retrieve message packet data in a communications network” are incorporated herein by reference in their entirety and for all purposes.

In addition, U.S. Pat. No. 7,360,217 (Inventors: Melvin, et al.; issued Apr. 15, 2008) entitled “Multi-threaded packet processing engine for stateful packet processing”; U.S. Pat. No. 7,039,851 (Inventor: Wang, et al.; issued May 2, 2006) entitled “Method of and apparatus for correcting errors in data packet flow streams as in closed ring sequential address generators and the like without data flow stream interruption”; U.S. Pat. No. 6,859,824 (Inventors: Yamamoto, et al.; issued Feb. 22, 2005) entitled “Storage system connected to a data network with data integrity”; and U.S. Pat. No. 6,456,782 (Inventors: Kubota, et al.; issued Sep. 24, 2002) entitled “Data processing device and method for the same” are incorporated herein by reference in their entirety and for all purposes.

### BRIEF DESCRIPTION OF THE DRAWINGS

These, and further features of the invention, may be better understood with reference to the accompanying specification and drawings depicting the preferred embodiment, in which:

FIG. 1 illustrates a network computer, or first preferred embodiment of the invented system, disposed between an electronics communications network and an internal electronics communications network;

FIG. 2 is a schematic of the network computer of FIG. 1.

FIG. 3 is a flow chart of certain aspects of a first preferred embodiment of the method of the present invention that may be performed by the network computer of FIG. 1;

FIG. 3 is a flow chart of certain additional aspects of a first preferred embodiment of the method of the present invention that may be performed by the network computer of FIGS. 1 and 2;

FIG. 4 is a flow chart of still other aspects of the method of the present invention that may be performed by the network computer of FIGS. 1 and 2;

FIG. 5 is a flow chart of yet additional aspects of the method of the present invention that may be performed by the network computer of FIGS. 1 and 2;

FIG. 6 illustrates a memory allocation design method of assigning memory resources of the network computer of FIGS. 1 and 2 for utilization as the plurality of queues of FIG. 1;

FIG. 7 illustrates an alternate memory allocation design method of assigning memory resources of the network computer of FIGS. 1 and 2 for utilization as the plurality of queues of FIG. 1; and

FIG. 8 illustrates a yet alternate memory allocation design method of assigning memory resources of the network computer of FIGS. 1 and 2 for utilization as the plurality of queues of FIG. 1.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

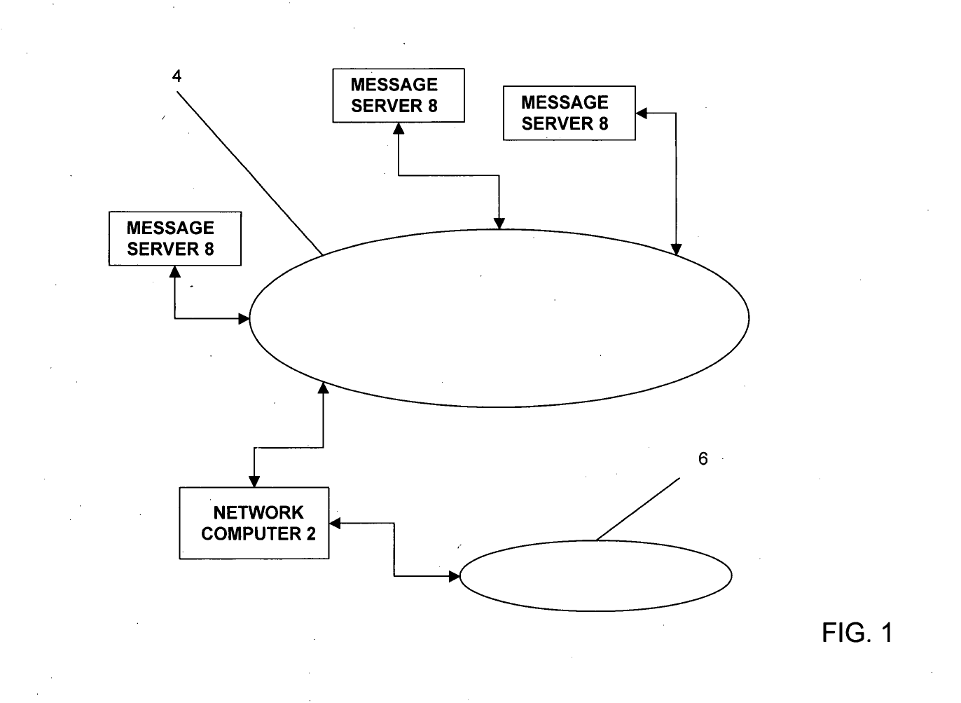

Referring now generally to the Figures and particularly to FIG. 1, FIG. 1 illustrates a network computer 2, or first preferred embodiment of the invented system 2, disposed between an electronics communications network 4 and an internal electronics communications network 6. The electronics communications network 4, or “network”, 4, may be or comprise the Internet, a computer network, a wireless communications network, and/or a telephony network. The internal communications network 6, or “internal network” 6, may be a computer network, an intranet, an extranet, a wireless communications network, a virtual private network, and/or a telephony network.

A plurality of message servers 8 transmit electronic messages through the network 4 and meant for delivery to elements of the internal network 6. These message may be or comprise Internet Protocol packets P.1-P.X that conform to the Internet Protocol version four or version six.

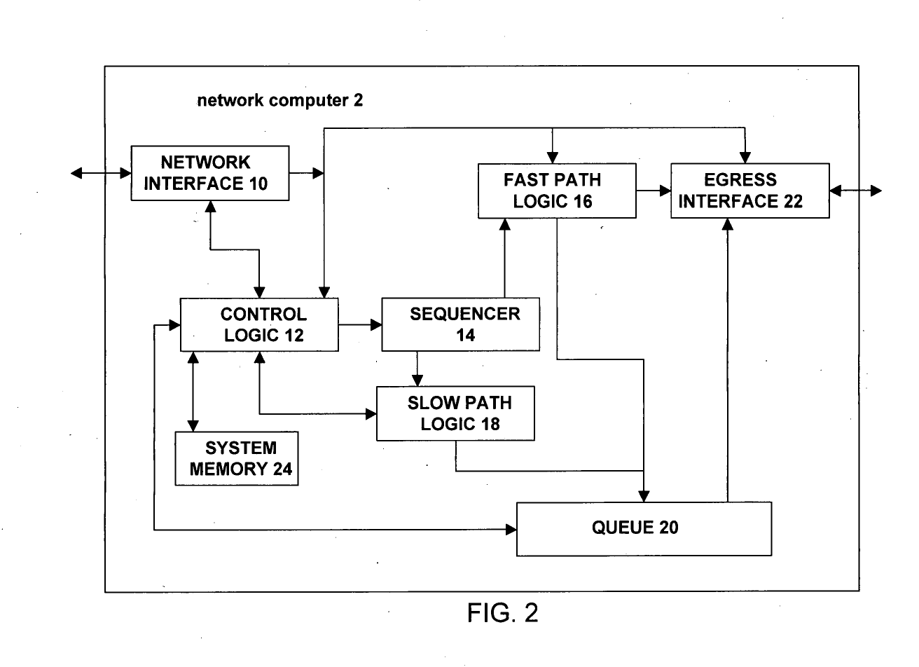

Referring now generally to the Figures and particularly to FIG. 2, FIG. 2 is a schematic of the network computer 2 of FIG. 1. The network computer 2, or “network computer” 2, includes a network interface 10 that bi-directionally communicatively couples the network computer 2 with the network 2, and enables the network computer 2 to receive an process Internet Protocol packets P.1-P.X.

The plurality Internet Protocol packets P.1-P.X, or “IP packets” P.1-P.X, comprise a data flow transmitted from one or more message servers 8 of the network 4. A control logic 12 directs the operations of a packet sequencer 14, a fast path logic 16, a slow path logic 18, a plurality of packet queues 20, an egress interface 22 and a system memory. The egress interface 22 bi-directionally communicatively couples the network computer with the internal network 6. The control logic 12 may be or comprise and applications specific integrated circuit, a microcontroller and/or a microprocessor programmed or configured to direct the elements 10-24 to process the IP packets P.1-P.X in accordance with the method of the present invention. A system memory 13 contains system software that directs and enables the control logic to program and/or configure fast path logic 16, the slow path logic 18 and other elements 10, 14, 20 & 22 to process the IP packets P.1-P.X in accordance with the method of the present invention.

The fast path logic 16 and/or the slow path logic 18 may be or comprise random access memory, programmable logic devices, and/or firmware. The control logic 12 may direct each received packets P.1-P.X to from the network interface 10 and to the fast path logic 16 or the sequencer 18. The sequencer adds order of arrival markers to each IP packet P.1-P.X directed by the control logic 12 to the sequencer 14.

Each IP packet P.1-P.X sent to the queue 20 flows through the sequencer 14 and either the fast path logic 16 or the slow path logic 18. The control logic 12 may direct the fast path logic to process and transfer IP packets P.1-.X to either the egress interface 22 or the queue 20. The plurality of queues 20 comprises reprogrammable memory circuit, such as random access memory. The control logic 12 may additionally direct the slow path logic to process and transfer IP packets P.1-.X to the egress interface 22.

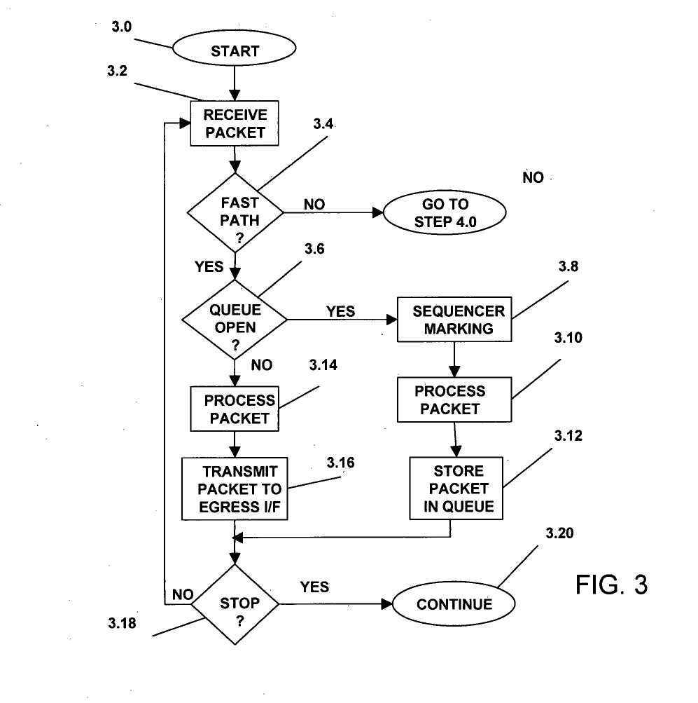

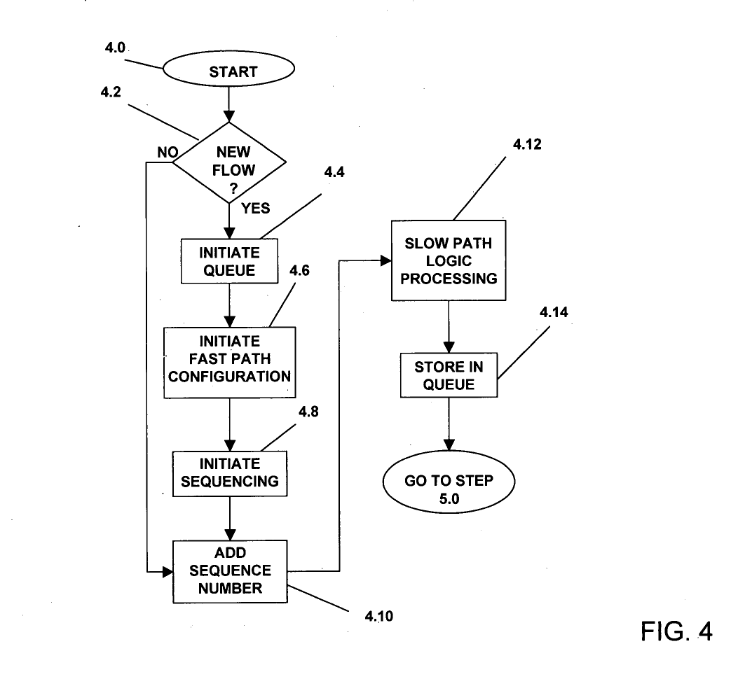

Referring now generally to the Figures, and particularly to FIG. 3, FIG. 3 is a flow chart of certain additional aspects of a first preferred embodiment of the method of the present invention. In step 3.2 the network computer 2 receives a packet P.1 of a first data flow D. The network interface 10 receives the packet P.1 and optionally calculates the an egress information for the packet P.1 in step 3.2. In step 3.4 the network computer determines whether a fast path logic has been configured and is available for IP packets P.1-P.X of the first data flow D. When the control logic determines in step 3.4 that a fast path logic is not available for IP packets P.1-P.X of the first data flow D, the network computer proceeds from step 3.4 to step 4.0. The processing of the IP packets P.1-P.X from step 4.0 is described below in reference to FIG. 4.

When the control logic 12 determines in step 3.4 that a fast path logic 16 is available for IP packets P.1-P.X of the first data flow D, the network computer proceeds from step 3.4 to step 3.6. The network computer 2 determines in step 3.6 whether a memory queue 20 is assigned and available to temporarily store IP packets P.1-P.X of the first data flow D. When the network computer 2 determines in step 3.6 that a memory queue 20 is assigned and available to temporarily store IP packets P.1-P.X of the first data flow D, the network computer 2 proceeds from step 3.6 to Step 3.8 wherein the packet P.1 the sequencer .x assigns an order of arrival marker to the IP packet P.1. Proceeding from step 3.8 to step 3.10, the network computer 2 processes the packet P.1 through the fast path logic 16 in step 3.10 and then stores the packet P.1 in step 3.12 within the assigned and available queue 20 after processing through the fast logic path 16 of step 3.10.

When the network computer 2 determines in step 3.6 that a memory queue 20 is not available to temporarily store IP packets P.1-P.X of the first data flow D, the network computer 2 proceeds from step 3.6 to step 3.14 and to process the packet P.1 through the fast path logic 16. The network computer 2 proceeds from step 3.14 to step 3.16 wherein the IP packet P.1 is transmitted to the egress interface 22. It is understood that the IP packet P.1 may be transmitted by the network computer 2 to the internal network 6 after the transfer of the IP packet P.1 to the egress interface 22.

The network computer 2 proceeds from either step 3.12 or step 3.16 to step 3.18, wherein the network computer determines whether to continue processing IP packets P.1-P.2 or to proceed on to other operations of step 3.20.

Referring now generally to the Figures and particularly to FIG. 4, FIG. 4 is a flow chart of still other aspects of the method of the present invention that may be performed by the network computer 2 of FIG. 1. In step 4.2 the network computer 2 determines whether a received IP packet P.1-P.X is a first received IP packet of the comprising data flow D. When the network computer 2 determines that a most recently received IP packet P.1-P.X is a first received IP packet of the comprising data flow D, the network computer 2 proceeds from step 4.2 to step 4.4 and dedicates a memory queue 20 for temporary storage of IP packets P.1-P.X of the data flow D. The network computer 2 additionally sets a related time counter TF to an initial start value. The time counter TF is incremented by a real time clock of the control logic 12 as the network computer proceeds on from step 4.4. In step 4.6 the network computer 2 initiates a configuration of the fast path logic 16, and in step 4.8 the network computer 2 directs the sequencer 14 to start incrementally assigning sequence numbers to the IP packets P.1-P.X of the same data flow D.

In step 4.10 a sequence number is added to, or associated with the IP packet P.1-P.X examined in step 4.2, and in step 4.12 the IP packet P.1-P.x of steps 4.2 and 4.10 is transmitted to, and processed by, the slow path logic 16. In step 4.14 the IP packet is stored in the queue 20 assigned to and available for storage of IP packets P.1-P.X. Optionally the sequence number assigned in step 4.10 may be stored in the assigned queue 20 or otherwise made available to the control logic 12.

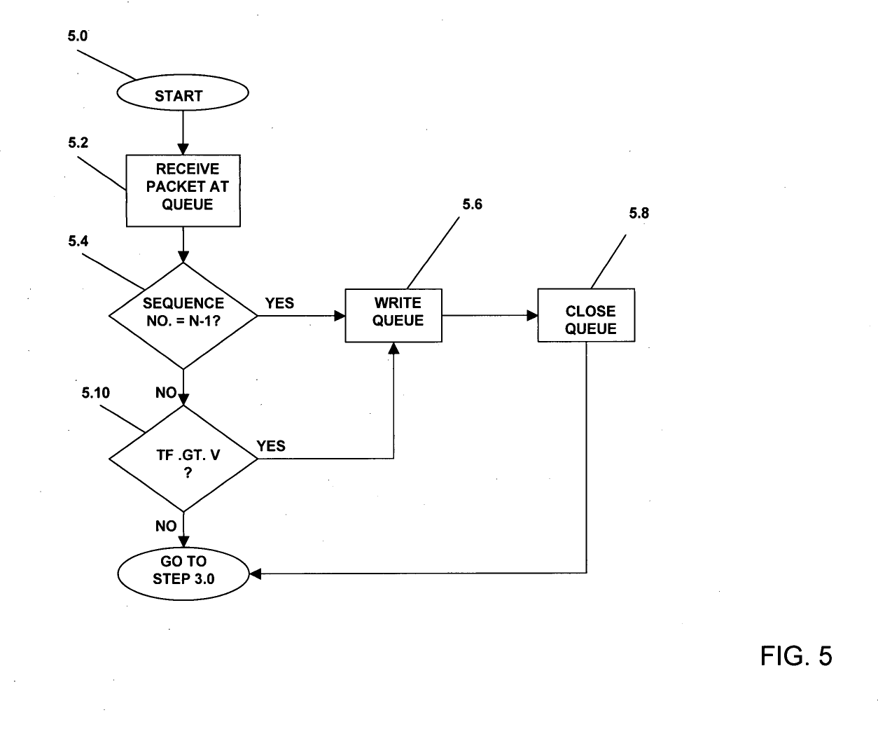

Referring now generally to the Figures and particularly to FIG. 5, FIG. 5 is a flow chart of yet additional aspects of the method of the present invention. In step 5.2 a packet P.1-P.X of the data flow D is received by the assigned and available queue 20. In step 5.4 the control logic 12 determines whether sequence number N of the IP packet P.1-P.X received in step 5.2 is equal to one less than a sequence number N, the sequence number N being equal to a sequence number of the first IP packet P.1-P.X received by the queue from after processing by the fast path logic 16.

Receipt of an IP Packet P.1-P.X having a sequence number of N−1 therefore indicates that all IP packets P.1-P.X assigned for processing by the slow path logic 18 have been fully processed and written into the assigned queue 20, and that the queue 20 may now write its contents to the egress interface 22, whereupon the queue 20 may be assigned to store packet of another data flow.

When the sequence number of the IP packet P.1-P.X is determined in step 5.2 to be equal to N−1, the control logic 12 directs the queue 20 in step 5.6 to write its contents to the egress interface 22. The control logic 12 then directs the queue 20 to be closed to and unavailable for receiving any remaining or additional IP packets P.1-P.x of the data flow D. In other words, after the execution of step 5.8, all remaining IP packets P.1-P.X of the data flow D are transmitted directly from the network interface 10 to the fast path logic 16, and from the fast path logic 16 to the egress interface 22 without mediation by the sequencer 14 or the queue 20.

When the sequence number of the IP packet P.1-P.X is determined in step 5.2 to not be equal to N−1, the control logic 12 compares the time counter TF with a maximum time value V. It is understood that the time value V is set to be equal to a value that indicates a failure to detect a completed processing of all IP packets P.1-P.X assigned to the slow logic path within a time period starting from a first assignment of the queue 20 to the data flow D indicates that one or more IP packet P.1-P.x assigned for processing by either the slow path logic 18 or the fast path logic 16 have been dropped in processing by the network computer 2. Step 5.10 thereby guards against hanging up the queue 20 and the network computer 2 when an IP packet P.1-P.X assigned is dropped by either the slow path logic 18 or the fast path logic 16.

When the time counter TF is determined by the network computer 2 in step 5.10 to exceed the max time value V, the network computer 2 proceeds from step 5.10 to step 5.6 and process step 5.6 and 5.8 as discussed above.

The network computer 2 proceeds from step 5.8 or step 5.10 to return to step 3.0.

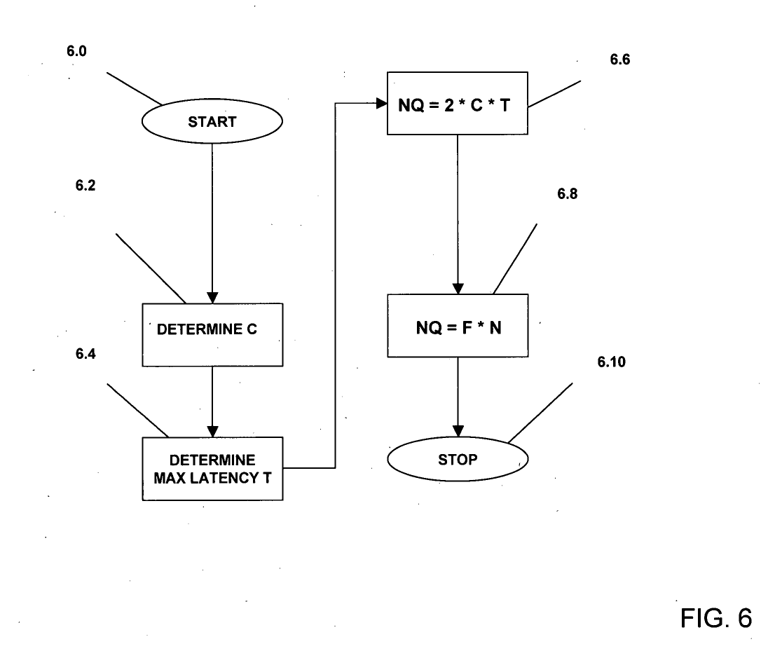

Referring now generally to the Figures and particularly to FIG. 6, FIG. 6 illustrates a memory allocation design method of assigning memory resources of the network computer 2 for utilization as the plurality of queues 20. In step 6.2 a connection rate C of the network computer 2 in receiving digital electronic content from the network is determined and in step 6.4 a maximum processing latency time T is determined. In step 6.8 a memory capacity allocation NQ is calculated as equal to twice the product of multiplying the connection rate C and the maximum time latency T.

In optional step 6.8 the memory allocation capacity NQ may be modified by multiplication with a design factor F. The design factor F is preferably approximate to the unity value of one and within the range of values 0.95 to 1.05. Alternatively, the design fact F may be a value selected from the value range of 0.8 to 1.20.

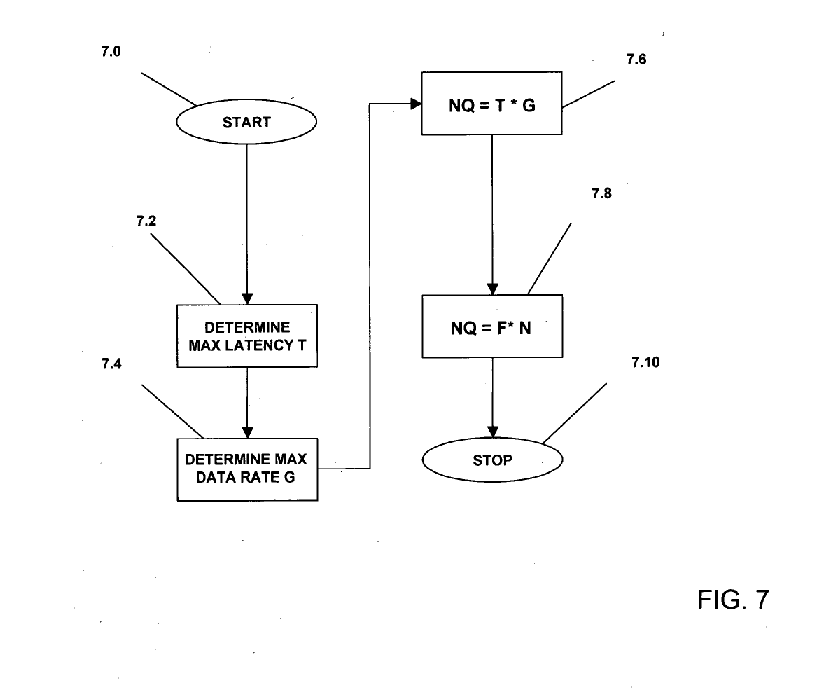

Referring now generally to the Figures and particularly to FIG. 7, FIG. 7 illustrates an alternate memory allocation design method of assigning memory resources of the network computer 2 for utilization as the plurality of queues 20. In step 7.2 a maximum processing latency time T is determined. In step 7.4 a maximum data rate G of the network computer is determined. And in step 7.6 a memory capacity allocation NQ is calculated as equal to the product of multiplying the maximum time latency T and the maximum data rate G of the network computer.

In optional step 7.8 the memory allocation capacity NQ may be modified by multiplication with a design factor F. The design factor F is preferably approximate to the unity value of one and within the range of values 0.95 to 1.05. Alternatively, the design fact F may be a value selected from the value range of 0.8 to 1.20.

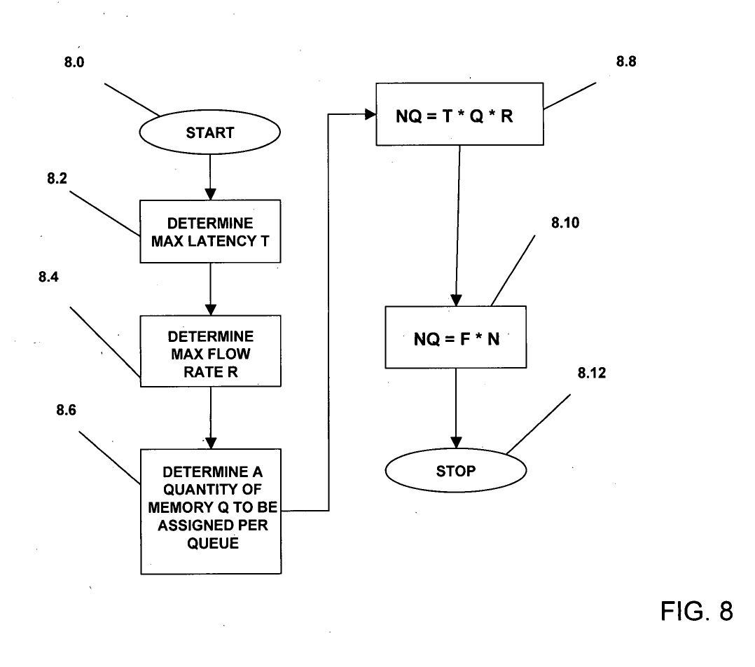

Referring now generally to the Figures and particularly to FIG. 8, FIG. 8 illustrates a yet alternate memory allocation design method of assigning memory resources of the network computer 2 for utilization as the plurality of queues 20. In step 8.2 a maximum processing latency time T is determined; in step 8.4 a maximum rate R of a single flow is determined; and in step 8.6 a quantity Q of resource queues is determined.

A memory capacity allocation NQ is calculated in step 8.10 as equal to the product of multiplying the maximum time latency T with the quantity Q of resource queues and with the quantity Q of resource queues.

In optional step 8.10 the memory allocation capacity NQ may be modified by multiplication with a design factor F. The design factor F is preferably approximate to the unity value of one and within the range of values 0.95 to 1.05. Alternatively, the design fact F may be a value selected from the value range of 0.8 to 1.20.

The foregoing disclosures and statements are illustrative only of the Present Invention, and are not intended to limit or define the scope of the Present Invention. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

We claim:

1. In a network computer communicatively coupled with an electronics communications network, the network computer having a memory resource comprising a plurality of queue resources, a method for restoring an arrival order of packets of flows, the method comprising:
a. transmitting a plurality of packets of a first data flow to the network computer;
b. processing the packets within the network computer; and
c. assigning a queue resource to the first data flow when a flow state of at least one packet transitions from a higher latency path to a lower latency path, the queue resource for storing each packet of the first data flow as each packet egresses from a processing path within the network computer.

2. The method of claim 1, wherein the higher latency path is at least partially implemented by software execution.

3. The method of claim 1, wherein the lower latency path is at least partially implemented by a hardware resource.

4. The method of claim 1, further comprising:
d. detecting the egress of a last packet of the flow through the higher latency path;
e. writing said last packet into the assigned queue resource;
f. egressing the contents of the assigned queue resource; and
g. releasing the assigned queue resource.

5. The method of claim 1, further comprising assigning a sequence number to each packet in an arrival order of the packets, the sequence number of each packet indicating the relative order of receipt by the network computer of the associated packet within a plurality of flows.

6. The method of claim 5, further comprising:
d. assigning a sequence number to each packet in order of receipt by the network computer;
f. writing at least two packets into the assigned queue resource;
g. reading a sequence number of a packet at the head of the assigned queue resource;
h. detecting receipt by the assigned queue resource of a packet having a sequence number issued after the allocation of the assigned queue resource;
i. egressing the stored packets of the first data flow from the assigned queue resource; and
j. releasing the assigned queue resource.

7. The method of claim 1, the method further comprising:
d. determining a maximum latency of a packet prior to receipt by the assigned queue resource; and
e. egressing all packets stored within the assigned queue resource after the maximum latency is exceeded.

8. The method of claim 7, the method further comprising releasing the assigned queue resource after each packet has egressed form the assigned resource queue.

9. A method of assigning memory resources of a network computer, the network computer communicatively coupled with an electronics communications network (“network”), the method comprising:
a. determining a connection rate C of the network computer in receiving digital electronic content from the network;
b. determining a maximum processing latency time T; and
c. assigning NQ queue resources to enable arrival order restoration of packets of flows received by the network computer, NQ having a memory capacity equal to 2 times C times T.

10. The method of claim 9, further comprising assigning a memory buffer having a capacity in the range of 0.8 to 1.2 the result of 2 times C times T.

11. A method of assigning a buffer memory resource of a network computer, the network computer communicatively coupled with an electronics communications network (“network”), the method comprising:
a. determining a maximum packet latency T;
b. determining a maximum data rate G of the network computer;
c. assigning a memory buffer size approximately equal to T times G for temporarily storing data packets.

12. The method of claim 11, further comprising assigning a memory buffer having a capacity in the range of 0.8 to 1.2 the result of T times G.

13. The method of claim 11, the method further comprising:
d. determining a maximum rate R of a single flow;
e. determining a quantity Q of resource queues; and
f. assigning a memory buffer size approximately equal to T times Q times R for temporarily storing data packets.

14. The method of claim 13, further comprising assigning a memory buffer having a capacity in the range of 0.8 to 1.2 the result of T times Q times R.

15. A network computer communicatively coupled with an electronics communications network (“network”), the network computer comprising:
a. means to transmit a plurality of packets of a same flow from the network and to the network computer;
b. means to process the packets within the network computer; and
c. means to assign a queue resource to the flow when a flow state of at least one packet transitions from a higher latency path to a lower latency path, the assigned queue resource for storing each packet of the flow as each packet egresses from a processing path within the network computer.

16. The network computer of claim 16, further comprising:
d. means to detect the egress of a last packet of the flow through the higher latency path;
e. means to write said last packet into the assigned queue resource; and
f. means to egress the contents of the assigned queue resource

17. The network computer of claim 16, further comprising means to release the assigned queue resource to store packets of a second data flow.

18. The network computer of claim 16, wherein the network is selected from the network group consisting of the Internet, an intranet, and extranet, a digital telephony system, a digital wireless communications system, and a computer network.

19. The network computer of claim 16, wherein the higher latency path is implemented at least partially by software execution.

20. The network computer of claim 16, wherein the network comprises the Internet and the packets conform to the Internet Protocol version four or six.
